(19) United States
(12) Patent Application Publication
(10) Pub. No.: US 2023/0347840 A1
(43) Pub. Date: Nov. 2, 2023

(54) THERMOELECTRIC CHARGING SYSTEM

(71) Applicant: Carrier Corporation, Palm Beach Gardens, FL (US)

(72) Inventors: Mary Saroka, Syracuse, NY (US); Jeffrey Burchill, Baldwinsville, NY (US)

(21) Appl. No.: 18/304,042

(22) Filed: Apr. 20, 2023

Related U.S. Application Data
(60) Provisional application No. 63/336,019, filed on Apr. 28, 2022.

(51) Int. Cl. B60R 16/03; H02J 7/00; F25D 11/00; B60R 16/033

(52) U.S. Cl. CPC B60R 16/0307; H02J 7/00711; F25D 11/003; B60R 16/033; B60P 3/20

(57) ABSTRACT

A charging system for a vehicle (e.g., equipped with a TRU and/or an APU) is provided. The charging system includes a battery. The charging system further includes a thermoelectric generator (TEG) module. The TEG module is thermally interposable between hot and cold zones of the vehicle. Being thermally interposable between the hot and cold zones of the vehicle, the TEG module is configured to generate electricity for charging the battery (e.g., of the TRU and/or the APU).

### CROSS-REFERENCE TO RELATED APPLICATIONS

This application claims the benefit of U.S. Provisional Application No. 63/336,019 filed Apr. 28, 2022, the disclosure of which is incorporated herein by reference in its entirety.

### BACKGROUND

The following description relates to charging systems and, more specifically, to a thermoelectric generator charging system for a transport refrigeration unit (TRU) and to a battery charging system for an auxiliary power unit (APU).

TRUs use low voltage (LV) direct current (DC) to power a controller, sensors and other LV DC components, such as DC fan motors, of the TRU. Typically, the LV DC power source is a battery. Thus, as battery energy is consumed during TRU operation, the battery eventually needs to be re-charged. Besides grid charging, it is desirable to be able to charge the LV battery while the unit is operating in the field.

APUs are used to provide cabin power for an idling tractor trailer. This power is used to run cabin air conditioning and support other LV DC loads. Until recently, the power was generated using a diesel engine and a generator. With the advent of lithium-ion battery technology, however, APUs are switching from engine/generator power to battery power sourcing. Traditional battery charging is done by plugging into the grid or using shore power while the tractor trailer is stationary.

### BRIEF DESCRIPTION

According to an aspect of the disclosure, a charging system for a transport refrigeration unit (TRU) of a vehicle is provided and includes a low-voltage (LV) direct current (DC) battery and a thermoelectric generator (TEG) module thermally interposable between a hot condenser air zone and a cold return air zone of the TRU to generate electricity for charging the LV DC battery.

In accordance with additional or alternative embodiments, a controller is electrically interposed between the TEG module and the LV DC battery to control a voltage and a current of the electricity applied to the LV DC battery.

In accordance with additional or alternative embodiments, the hot condenser air zone includes a flow of condenser air at about 40-50° C. and the cold return air zone comprises a flow of return air at about −20-0° C.

In accordance with additional or alternative embodiments, an insulating barrier is between the hot condenser air zone of a condenser section of the TRU and the cold return air zone into which cold return air flows from a cargo compartment, and the TEG module is disposed at the insulating barrier.

In accordance with additional or alternative embodiments, the TEG module comprises one of a lattice of individual TEGs disposed in series, a lattice of individual TEGs disposed in parallel and a lattice of individual TEGs disposed in an adjustable electrical arrangement.

According to an aspect of the disclosure, a charging system for an auxiliary power unit (APU) of a vehicle is provided and includes a low-voltage (LV) direct current (DC) battery and a thermoelectric generator (TEG) module thermally interposable between a region into which hot engine exhaust is directed and a region of ambient air to generate electricity for charging the LV DC battery.

In accordance with additional or alternative embodiments, a controller is electrically interposed between the TEG module and the LV DC battery to control a voltage and a current of the electricity applied to the LV DC battery.

In accordance with additional or alternative embodiments, the TEG module is disposed on an exhaust pipe carrying the hot engine exhaust.

In accordance with additional or alternative embodiments, a thermal barrier between the region in which the hot engine exhaust is directed and the region of ambient air.

In accordance with additional or alternative embodiments, the TEG module includes one of a lattice of individual TEGs disposed in series, a lattice of individual TEGs disposed in parallel and a lattice of individual TEGs disposed in an adjustable electrical arrangement.

According to an aspect of the disclosure, a charging system for a vehicle is provided and includes a battery and a thermoelectric generator (TEG) module thermally interposable between hot and cold zones of the vehicle to generate electricity for charging the battery.

In accordance with additional or alternative embodiments, the battery includes at least one of a low-voltage (LV) direct current (DC) battery of a transport refrigeration unit (TRU) and an LV DC battery of an auxiliary power unit (APU) of the vehicle.

In accordance with additional or alternative embodiments, the hot zone is at least one of an interior of a transport refrigeration unit (TRU) of the vehicle, a region into which engine exhaust of the vehicle is directed and a region proximate to a radiative surface of the vehicle.

In accordance with additional or alternative embodiments, a controller is electrically interposed between the TEG module and the battery to control a voltage and a current of the electricity applied to the battery.

In accordance with additional or alternative embodiments, an insulating barrier is between the hot and cold zones, and the TEG module is disposed at the insulating barrier.

In accordance with additional or alternative embodiments, a thermal barrier is thermally interposed between the hot zone and the TEG module.

In accordance with additional or alternative embodiments, a position of the TEG module between the hot and cold zones is adjustable.

In accordance with additional or alternative embodiments, the TEG module includes a lattice of individual TEGs disposed in series.

In accordance with additional or alternative embodiments, the TEG module comprises a lattice of individual TEGs disposed in parallel.

In accordance with additional or alternative embodiments, the TEG module includes a lattice of individual TEGs disposed in an adjustable electrical arrangement.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features and advantages of the disclosure are apparent from the following detailed description taken in conjunction with the accompanying drawings in which:

FIG. 1 depicts a tractor trailer system having a TRU and a cargo compartment in accordance with exemplary embodiments;

FIG. 2 depicts a TRU for a cargo compartment of the tractor trailer system of FIG. 1 in accordance with exemplary embodiments;

FIG. 3 is a schematic illustration of a charging system in accordance with exemplary embodiments;

FIG. 4 is a schematic diagram of a thermoelectric generator (TEG) module of a charging system with individual TEGs in series in accordance with exemplary embodiments;

FIG. 5A is a schematic diagram of a TEG module of a charging system with individual TEGs in parallel in accordance with exemplary embodiments;

FIG. 5B is a schematic diagram of a TEG module of a charging system with groups of individual TEGs in parallel in accordance with exemplary embodiments;

FIG. 6 is a schematic illustration of a charging system for a battery of a TRU in accordance with exemplary embodiments;

FIG. 7 is a perspective view of an insulating barrier with a TEG module between hot and cold zones of the TRU of FIG. 6 in accordance with exemplary embodiments;

FIG. 8 is a front view of the insulating barrier with the TEG module of FIG. 7 in accordance with exemplary embodiments;

FIG. 9 is a schematic illustration of a charging system for a battery of an APU of a vehicle in accordance with exemplary embodiments; and

FIG. 10 is a side view of the vehicle of FIG. 9 with a TEG module of the charging system of FIG. 9 in accordance with exemplary embodiments.

### DETAILED DESCRIPTION

As will be described below, a LV DC charging system for a transport refrigeration unit (TRU) and to a battery charging system for an auxiliary power unit (APU) are provided, which use thermoelectric generators (TEGs) and existing temperature differences (e.g., between a condensing (hot) section and an evaporator/cargo (cold) section that results from operations of a TRU while a tractor trailer is moving or on a delivery run). It is envisioned that by placing one or more TEGs between sections where temperature differentials are present, thermal energy can be used to generate electrical energy for the TRU and/or APU.

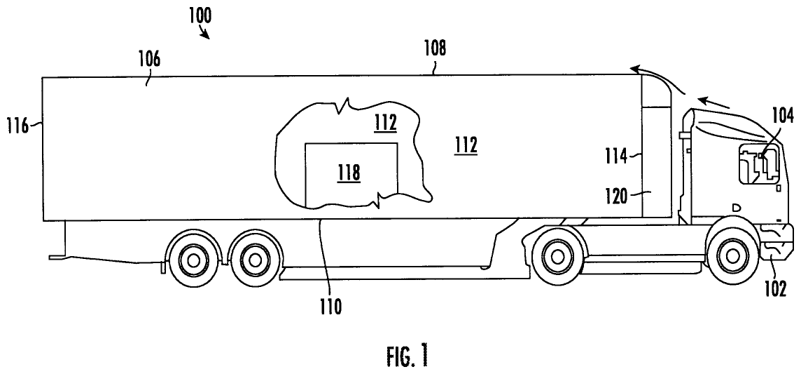

With reference to FIG. 1, an exemplary tractor trailer system 100 is provided. The tractor trailer system 100 includes a tractor 102 including an operator's compartment or cab 104 and an engine, which acts as the drive system of the tractor trailer system 100. A trailer 106 is coupled to the tractor 102. The trailer 106 is a refrigerated trailer 106 and includes a top wall 108, a directly opposed bottom wall 110, opposed side walls 112, and a front wall 114, with the front wall 114 being closest to the tractor 102. The trailer 106 further includes a door or doors (not shown) at a rear wall 116, opposite the front wall 114. The walls of the trailer 106 define a cargo compartment. The trailer 106 is configured to maintain a cargo 118 located inside the cargo compartment at a selected temperature through the use of a transport refrigeration unit 120 located on the trailer 106. The transport refrigeration unit 120, as shown in FIG. 1, can be located at or attached to the front wall 114.

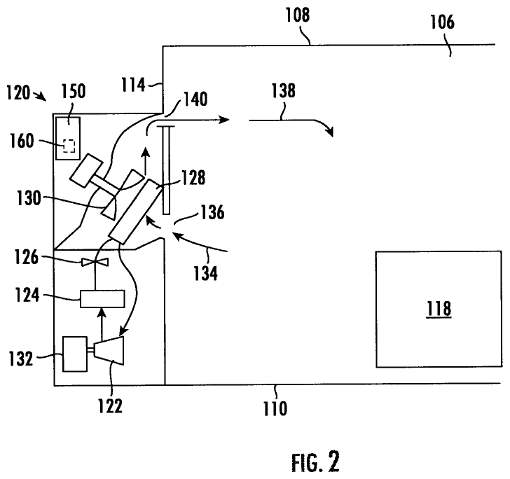

With reference to FIG. 2, the transport refrigeration unit 120 of FIG. 1 is shown in more detail. The transport refrigeration unit 120 includes a compressor 122, a condenser 124, an expansion valve 126, an evaporator 128, and an evaporator fan 130. The compressor 122 is operably connected to a power source 132, which drives the compressor 122. Airflow is circulated into and through the cargo compartment of the trailer 106 by means of the transport refrigeration unit 120. A return airflow 134 flows into the transport refrigeration unit 120 from the cargo compartment of the trailer 106 through a refrigeration unit inlet 136 and across the evaporator 128 via the evaporator fan 130, thus cooling the return airflow 134. The cooled return airflow 134, now referred to as supply airflow 138, is supplied into the cargo compartment of the trailer 106 through a refrigeration unit outlet 140, which in some embodiments is located near the top wall 108 of the trailer 106. The supply airflow 138 cools the cargo 118 in the cargo compartment of the trailer 106. Also included in the cargo compartment can be a refrigerant leak sensor 150 for detecting a leak of a particular type of refrigerant or substance. It is to be understood that the refrigerant leak sensor 150 can be located in different locations in the system and is not limited by the example shown in FIG. 2. For example, the refrigerant leak sensor 150 can be located in the evaporator section of the transport refrigeration unit 120, a different portion of the cargo compartment of the trailer 106 or another location in the system. Upon detection by the refrigerant leak sensor 150, a signal can be transmitted to controller 160. The controller 160 controls various aspects of the transport refrigeration unit 120 and the transport refrigeration unit power system. The controller 160 can control the compressor 122, the condenser 124, the expansion valve 126, the evaporator 128, and the evaporator fan 130 in addiction to other equipment or sensors. The controller 160 can be connected to the equipment over a wired or wireless connection (connections not shown). In some cases, the controller 160 can be configured to perform a low charge diagnostics calculation which is used to perform various calculations of the refrigeration system of the transport refrigeration unit 120 to determine a state of operation. In other embodiments, the low charge diagnostics calculation can be performed in a cloud network (not shown in FIG. 2).

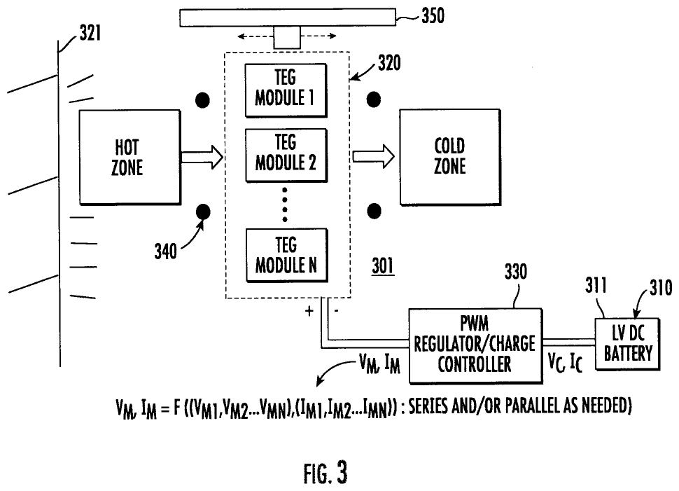

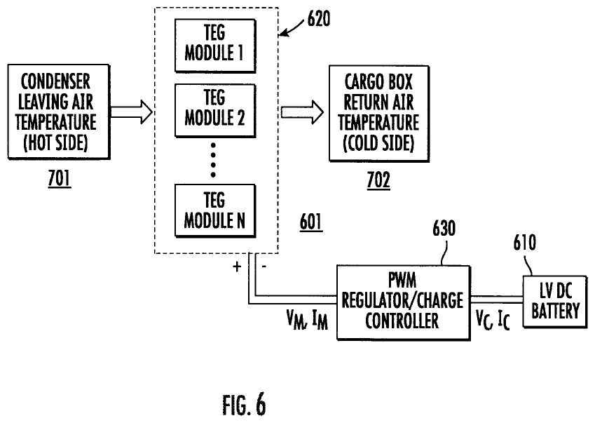

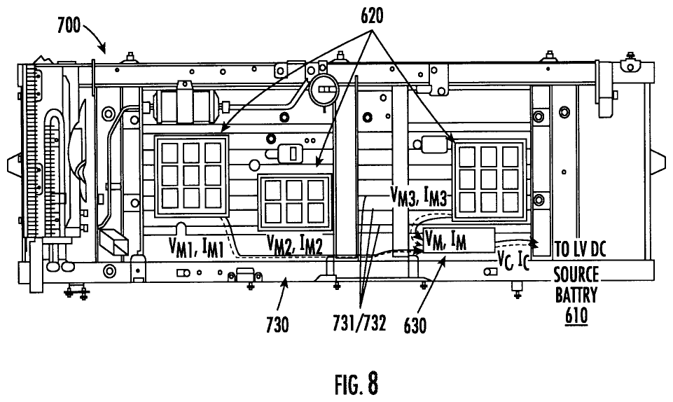

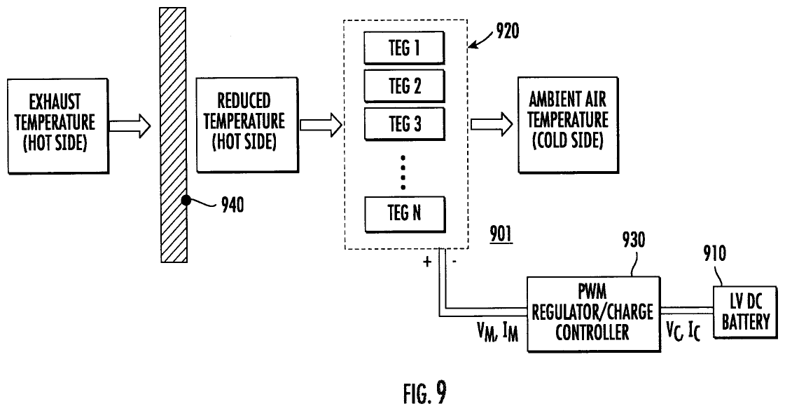

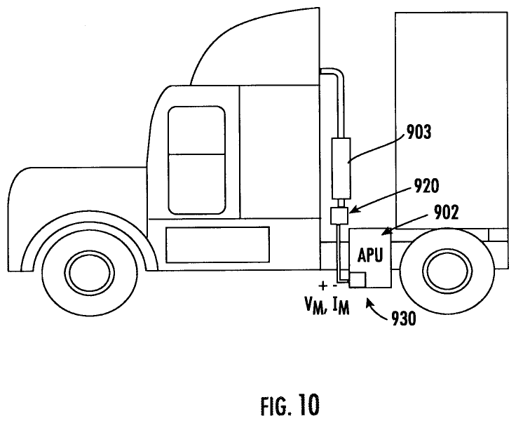

With reference to FIG. 3, an exemplary charging system 301 is provided, which could be used for a ground-based vehicle (e.g., a tractor trailer equipped with a transport refrigeration unit (TRU) and/or an auxiliary power unit (APU)) or an aircraft. The charging system 301 includes a battery 310 and a TEG module 320. The battery 310 can be provided as an LV DC battery 311 of, for example, a TRU such as the transport refrigeration unit 120 of FIG. 2 and/or an APU of the tractor 102 of FIG. 1. The TEG module 320 is thermally interposable between hot and cold zones to generate electricity for charging the battery 310. In accordance with embodiments, the hot zone can be at least one or more of an interior of a TRU (see FIGS. 6-8 and accompanying text), a region into which engine exhaust of the vehicle is directed (see FIGS. 9 and 10 and accompanying text) and a region proximate to a radiative surface, such as a surface 321 of a vehicle that heats up in sunlight during the course of a day in service.

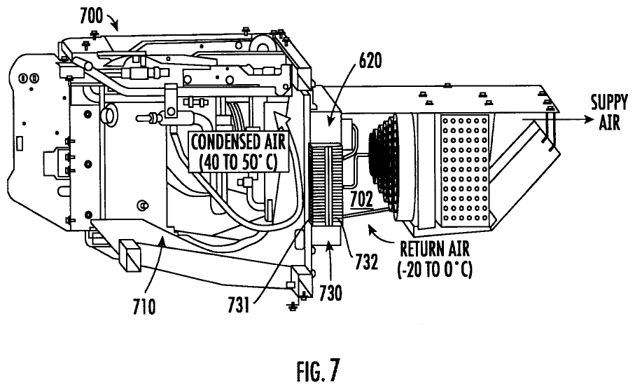

The charging system 301 can further include a controller 330, such as a pulse width modulation (PWM) controller or a charge controller, which is electrically interposed between the TEG module 320 and the battery 310 to control at least one or more of a voltage and a current of the electricity applied to the battery 310. In addition, in some cases, the charging system 301 can include at least one or more of an insulating barrier 730 between the hot and cold zones (see FIG. 7 and accompanying text) and a thermal barrier 940 thermally interposed between the hot zone and the TEG module 320 (see FIG. 9 and accompanying text). In these or other cases, as shown in FIG. 1, a position of the TEG module 320 between the hot and cold zones can be adjustable to optimize performance of the TEG module 320 without risking (or at least minimizing) thermal damage to the TEG module 320.

While the TEG module 320 provides optimal electrical performance where AT between the hot and cold zones is high (e.g., 50° C. or more), the TEG module 320 may be rated for service in conditions having a maximum temperature of 200° C. Thus, it is conceivable that the TEG module 320 could be optimally positioned between hot and cold zones for electrical performance and be exposed to excessive temperatures. In these or other cases, the charging system 301 can further include a sensor array 340 to sense temperatures between hot and cold zones where the TEG module 320 could be disposed and a servo element 350 configured to position the TEG module 320 for optimal electrical performance without risking thermal damage to the TEG module 320. Here, the controller 330 or another computing device could be used to analyze the readings of the sensor array 340 and to control an operation of the servo element 350 accordingly.

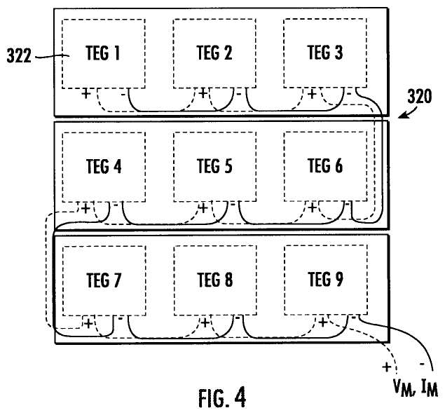

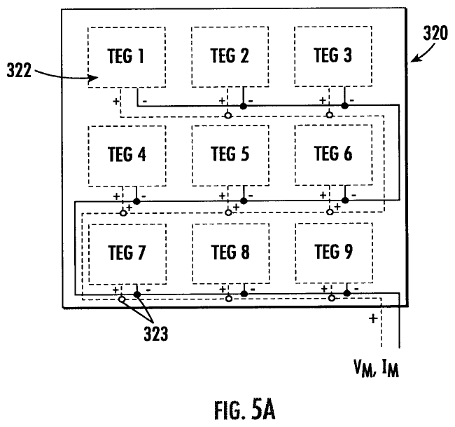

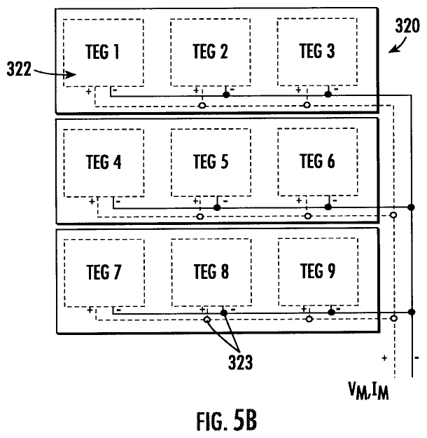

With reference to FIGS. 4, 5A, and 5B, the TEG module 320 can include a lattice of individual TEGs 322 that are disposed in series (see FIG. 4), in parallel (see FIG. 5A), and a lattice of individual TEGs 322 that are disposed in parallel groups of TEGs 322 (see FIG. 5B) or in other electrical arrangements. As an additional or alternative embodiment, the TEG module 320 can include a lattice of individual TEGs 322 as well as an array of switches 323 (see FIGS. 5A and 5B) that can be engaged and disengaged such that the lattice of individual TEGs 322 can be disposed in an adjustable electrical arrangement, such as a partially or wholly serial and/or a partially or wholly parallel electrical arrangement. The switches 232 can be engaged or disengaged based on a type of each individual TEG 322 in the TEG module 320 and based on a total amount of current and voltage the TEG module 320 is required to generate electricity given current conditions. In any case, it is to be understood that a capability of the TEG module 320 to charge the battery 310 is largely dependent on a voltage and a current the TEG module 320 can generate, which is in turn largely dependent on designs of the individual TEGs 322 and their wiring pattern(s).

In an exemplary case, if TEGₓ, can generate 0.3 A, 1.5V max, the TEG module 320 in the series arrangement of FIG. 4 can generate a current of 0.3 A with a voltage of Vm1 of 9×1.5V max for a total of 13.5 VDC. Further using 3 of these TEG modules in a parallel arrangement can generate a current of 3×0.3 A for a total system current of 0.9 A and voltage of 13.5 VDC.

With reference to FIGS. 6-8, a charging system 601 is provided for use with a TRU 700 of a vehicle (see FIG. 7), such as the transport refrigeration unit 120 of FIG. 2. The charging system 601 includes an LV DC battery 610 and a TEG module 620, which is thermally interposable between a hot condenser air zone 701 and a cold return air zone 702 of the TRU 700 to generate electricity for charging the LV DC battery 610. The charging system 601 can further include a controller 630, such as a PWM or charge controller, which is electrically interposed between the TEG module 620 and the LV DC battery 610 to control a voltage and a current of the electricity applied to the LV DC battery 610.

In accordance with embodiments, the hot condenser air zone 701 can be characterized in that it is located within a condenser section 710 of the TRU 700 and thus hosts a flow of condenser air at about 40-50° C. and the cold return air zone 702 can be characterized in that it hosts a flow of cold return air flowing from a cargo compartment 720, such as the cargo compartment of the trailer 106 of FIG. 1, at about −20-0° C. In these or other cases, the charging system 601 can include an insulating barrier 730 between the hot condenser air zone 701 and the cold return air zone 702. The TEG module 620 can be disposed at, on or as part of the insulating barrier 730 as shown in FIGS. 7 and/or with the TEG module 620 or the insulating barrier 730 further including first fins 731 facing the hot condenser air zone 701 and second fins 732 facing the cold return air zone 702.

With continued reference to FIGS. 6-8 and with reference back to FIGS. 4 and 5, it is to be understood that the TEG module 620 can include at least one or more of a lattice of individual TEGs disposed wholly or partially in parallel, a lattice of individual TEGs disposed wholly or partially in series, and a lattice of individual TEGs disposed in an adjustable electrical arrangement as shown in FIGS. 4 and 5.

With reference to FIGS. 9 and 10, a charging system 901 is provided for use with an APU 902 of a vehicle, such as the tractor 102 of FIG. 1. The charging system 901 includes an LV DC battery 910 and a TEG module 920, which is thermally interposable between a region into which hot engine exhaust of the vehicle is directed and a region of ambient air to generate electricity for charging the LV DC battery 910. The charging system 901 can further include a controller 930, such as a PWM or charge controller, which is electrically interposed between the TEG module 920 and the LV DC battery 910 to control a voltage and a current of the electricity applied to the LV DC battery 910.

In accordance with embodiments and as shown in FIG. 10, the TEG module 920 can be disposed on or proximate to an exhaust pipe 903 of the vehicle that carries the hot engine exhaust. In these or other cases, as shown in FIG. 9, the charging system 901 can also include a thermal barrier 940 between the region in which the hot engine exhaust is directed and the region of ambient air. This thermal barrier 940 serves to protect the TEG module 920 from thermal damage without requiring that the TEG module 920 be so far removed from the region in which the hot engine exhaust is directed that the electrical performance of the TEG module 920 is otherwise degraded.

With continued reference to FIGS. 9 and 10 and with reference back to FIGS. 4 and 5, it is to be understood that the TEG module 920 can include at least one or more of a lattice of individual TEGs disposed wholly or partially in parallel, a lattice of individual TEGs disposed wholly or partially in series and a lattice of individual TEGs disposed in an adjustable electrical arrangement as shown in FIGS. 4 and 5.

Technical effects and benefits of the present disclosure are the provision of a charging system for a vehicle that includes a battery and a TEG module thermally interposable between hot and cold zones of the vehicle to generate electricity for charging the battery even while the vehicle is moving or on a delivery run. The battery could be a battery of a TRU that provides LV DC to various components of the TRU. Alternatively or additionally, the battery could be a battery of an APU used to provide cabin power for an idling tractor trailer and to run cabin air conditioning and to support other LV DC loads.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A charging system for a transport refrigeration unit (TRU) of a vehicle, the charging system comprising:
a low-voltage (LV) direct current (DC) battery; and
a thermoelectric generator (TEG) module thermally interposable between a hot condenser air zone and a cold return air zone of the TRU to generate electricity for charging the LV DC battery.

2. The charging system according to claim 1, further comprising a controller electrically interposed between the TEG module and the LV DC battery to control a voltage and a current of the electricity applied to the LV DC battery.

3. The charging system according to claim 1, wherein the hot condenser air zone comprises a flow of condenser air at about 40 to 50° C. and the cold return air zone comprises a flow of return air at about −20 to 0° C.

4. The charging system according to claim 1, further comprising an insulating barrier between the hot condenser air zone of a condenser section of the TRU and the cold return air zone into which cold return air flows from a cargo compartment, wherein the TEG module is disposed at the insulating barrier.

5. The charging system according to claim 1, wherein the TEG module comprises one of a lattice of individual TEGs disposed in series, a lattice of individual TEGs disposed in parallel and a lattice of individual TEGs disposed in an adjustable electrical arrangement.

6. A charging system for an auxiliary power unit (APU) of a vehicle, the charging system comprising:
a low-voltage (LV) direct current (DC) battery; and
a thermoelectric generator (TEG) module thermally interposable between a region into which hot engine exhaust is directed and a region of ambient air to generate electricity for charging the LV DC battery.

7. The charging system according to claim 6, further comprising a controller electrically interposed between the TEG module and the LV DC battery to control a voltage and a current of the electricity applied to the LV DC battery.

8. The charging system according to claim 6, wherein TEG module is disposed on an exhaust pipe carrying the hot engine exhaust.

9. The charging system according to claim 6, further comprising a thermal barrier between the region in which the hot engine exhaust is directed and the region of ambient air.

10. The charging system according to claim 6, wherein the TEG module comprises one of a lattice of individual TEGs disposed in series, a lattice of individual TEGs disposed in parallel and a lattice of individual TEGs disposed in an adjustable electrical arrangement.

11. A charging system for a vehicle, comprising:
a battery; and
a thermoelectric generator (TEG) module thermally interposable between hot and cold zones of the vehicle to generate electricity for charging the battery.

12. The charging system according to claim 11, wherein the battery comprises at least one of a low-voltage (LV) direct current (DC) battery of a transport refrigeration unit (TRU) and an LV DC battery of an auxiliary power unit (APU) of the vehicle.

13. The charging system according to claim 11, wherein the hot zone is at least one of an interior of a transport refrigeration unit (TRU) of the vehicle, a region into which engine exhaust of the vehicle is directed and a region proximate to a radiative surface of the vehicle.

14. The charging system according to claim 11, further comprising a controller electrically interposed between the TEG module and the battery to control a voltage and a current of the electricity applied to the battery.

15. The charging system according to claim 11, further comprising an insulating barrier between the hot and cold zones, wherein the TEG module is disposed at the insulating barrier.

16. The charging system according to claim 11, further comprising a thermal barrier thermally interposed between the hot zone and the TEG module.

17. The charging system according to claim 11, wherein a position of the TEG module between the hot and cold zones is adjustable.

18. The charging system according to claim 11, wherein the TEG module comprises a lattice of individual TEGs disposed in series.

19. The charging system according to claim 11, wherein the TEG module comprises a lattice of individual TEGs disposed in parallel.

20. The charging system according to claim 11, wherein the TEG module comprises a lattice of individual TEGs disposed in an adjustable electrical arrangement.
